(19) United States
(12) Patent Application Publication
(10) Pub. No.: US 2008/0145281 A1
(43) Pub. Date: Jun. 19, 2008

(54) Gas oxygen incinerator

(76) Inventor: Richard A. Jenne, Oregon, OH (US)

Correspondence Address: OWENS CORNING, 2790 COLUMBUS ROAD, GRANVILLE, OH, 43023, US

(21) Appl. No.: 11/638,758

(22) Filed: Dec. 14, 2006

(51) Int. Cl. B01D 53/34

(52) U.S. Cl. 422/168; 110/212

(57) ABSTRACT

The present invention provides an incinerator and a method of firing an incinerator. The incinerator is provided with an oxygen fuel burner. The incinerator is fed with a exhaust stream that includes various impurities such as NOₓ, CHO₂, NH₃, and C₆H₅OH. The exhaust gasses are heated to a temperature high enough to react the impurities to form benign compounds such as CO₂, H₂O and N₂. The burner may be fed with a rich fuel air mixture to improve combustion and to reduce the amount of oxygen required. The flow of gaseous fuel and oxygen to the oxygen-fuel burner are controlled such that the oxygen is less than the stoichiometric ratio required to drive the combustion reaction to completion. The reaction therefore relies upon oxygen within the exhaust stream to drive the combustion reaction to completion. The invention provides an exhaust stream with fewer impurities while consuming less oxygen and fuel therefore cutting operational costs.

### TECHNICAL FIELD AND INDUSTRIAL APPLICABILITY OF THE INVENTION

This invention relates to a fume incinerator having at least one oxygen-fuel burner for reducing the production of nitrous oxide. The oxygen-fuel burner in the incinerator has an infeed of a combustible gas, such as natural gas, as well as an infeed of an oxidizing gas that includes oxygen at higher than atmospheric levels. The present invention controls the flow of the combustion gas and the oxidizing gas such that the oxidizing gas is at less than the stoichiometric ratio of oxygen to combustion gas. This sub-stoichiometric level allows the combustion gas to react with the oxygen contained in the fumes, provides a cleaner exhaust stream, and reduces the amount of oxygen required to fire the oxygen-fuel burner.

### BACKGROUND OF THE INVENTION

Industrial ovens such as curing ovens used in the manufacture of fiberglass may produce an exhaust stream, which may include oxygen (O₂), nitrogen (N₂), formaldehyde (CHO₂), ammonia NH₃) and other impurities. This exhaust stream, commonly referred to as fumes, is generally incinerated to reduce emissions. Within an incinerator, a combustion gas such as methane is introduced with the fumes and combustion occurs. Typically, this combustion results in the formation of NOₓ, as well as incomplete combustion of the N₂, CHO₂, and NH₃ or other impurities. This may result in NOₓ, N₂, CHO₂, NH₃ and other pollutants may be released to the atmosphere.

Oxy-fuel burners are used in industrial heating such as in a melting chamber for glass. It has been known to employ oxygen-fuel burners in a number of furnaces to supplement or replace air-fuel burners. Oxygen-fuel burners have been designed to produce a flame and heat transfer similar to that of convention air-fuel burners. Specifically, the oxygen fuel burners are designed to include a stoichiometric level of oxygen with respect to the level of combustion gas. That is, the oxygen and combustion gas are added to the burner in so that the combustion gas is completely consumed by the oxygen supplied to the oxygen-fuel burner.

The methane combustion reaction is shown in Formula 1.

CH₄+2O₂→CO₂+2H₂O (Formula 1)

Typically, in an oxygen-fuel burner 103% of the oxygen required to meet the stoichiometric reaction is supplied to provide for complete combustion of the methane. The heat of combustion is used to drive another reaction, for example the melting of batch materials to form glass.

It is an object of the invention to increase the quality of combustion within an incinerator without overheating the roof and walls of the incinerator by the use of an oxygen-fuel burner. It is another object of the invention to reduce the formation of NOₓ within the incinerator. Yet another object of the present invention is to reduce the emissions of NOₓ, CHO₂, NH₃, C₆H₅OH and other pollutants. Still another object of the present invention is to reduce the total energy required over conventional air-fuel incinerators.

### SUMMARY OF THE INVENTION

The present invention is a fume incinerator having at least one oxygen-fuel burner for reducing the production of nitrous oxide. The oxygen-fuel burner in is fed with a combustible gas, such as methane, and an oxidizing gas, such as oxygen that includes oxygen at higher than atmospheric levels. In the present invention, the oxidizing gas may be supplied to the burner at less than the stoichiometric ratio of oxygen to combustion gas. This sub-stoichiometric level allows the combustion gas to react with the oxygen contained in the fumes, provides a cleaner exhaust stream, and reduces the amount of oxygen required to fire the oxygen-fuel burner. The method of the present invention introduces the oxidizing gas at as low as about 25% of the stoichiometric level of oxygen required to oxidize the combustion gas. The bulk of the oxidizing gas is derived from the fumes. The low amount of oxidizing gas, with respect to the amount of combustion gas is referred to as a rich fuel mix. A rich fuel mixture has previously been avoided in oxygen-fuel burners because it does not burn completely. It has been discovered that the use of the previously considered undesirable rich mixture in combination with the fumes results in a cleaner exhaust stream. The present invention also provides the cleaner exhaust stream at lower cost do to lower amount of oxygen required for combustion.

### BRIEF DESCRIPTION OF THE DRAWINGS

Further features and other objects and advantages of this invention will become clear from the following detailed description made with reference to the drawings in which:

FIG. 1 is a cross-sectional plan view of a oxygen-fuel burner suitable for use with the present invention;

FIG. 2 is a cross-sectional plan view of a incinerator in accordance with an embodiment of the present invention in combination with a curing oven; and

FIG. 3 is a cross-sectional plan view of an incinerator in accordance with another embodiment of the present invention in combination with a curing oven.

### DETAILED DESCRIPTION AND PREFERRED EMBODIMENTS OF THE INVENTION

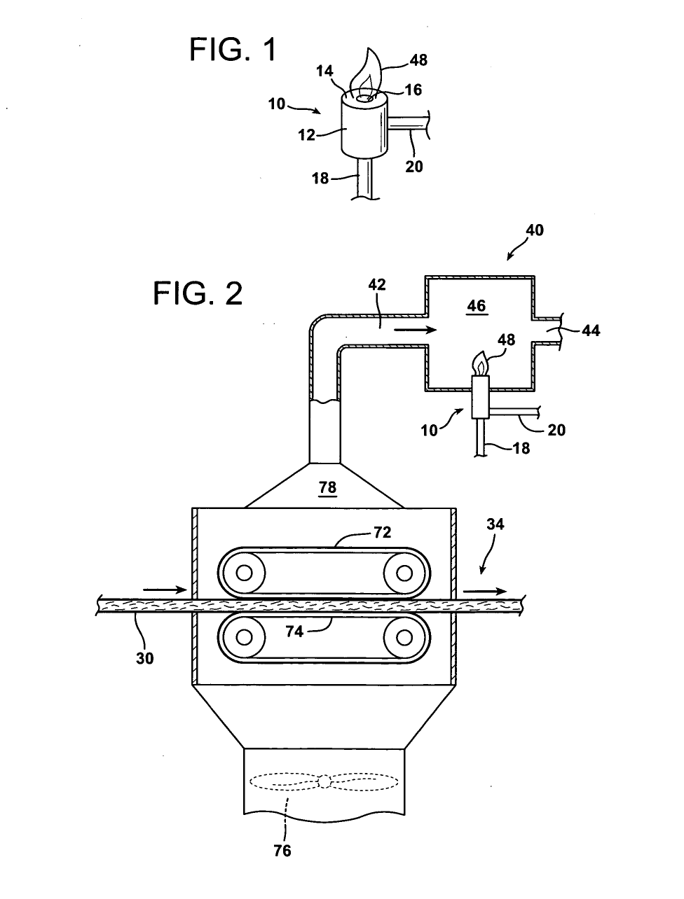

Referring to the figures, there is shown in FIG. 1 a burner 10, suitable for use in the present invention. The burner 10 includes a body 12, which typically contains an outer lumen 14 and an inner lumen 16. The inner lumen is typically connected to an oxygen source (not shown). The oxygen source may be a tank of industrial grade oxygen or may be any source 20 of oxygen at higher than an atmospheric concentration of oxygen. The outer lumen 14 is connected to a source 18 of a combustion fuel. Methane is one common combustion fuel although other flammable gasses such as propane may be used.

FIG. 2 shows a curing oven used in a fiberglass-curing oven 70 that is linked to an incinerator 40. An uncured pack 30 exits the forming section of a typical fiberglass forming section (not shown) and enters curing oven 70. The uncured pack 30 is compressed between the upper curing oven chain 72 and the lower curing oven chain 74. Heated air is forced from fan 76 through the lower chain 72, the pack 30 and upper chain 74 to cure the binder in pack 30 and to adhere the glass fibers to one another to form a blanket of cured fiberglass 34. The heated air passes out of the curing oven 70 through exhaust section 78. The exhaust 78 is coupled to an incinerator 40 via conduit 42. The exhaust gasses are typically maintained at about 450 F to inhibit condensation within conduit 42 and to reduce the potential for fire. The exhaust gasses enter the chamber 46 of incinerator where they are impinged by a flame 48 from burner 10 the impurities, such as NOₓ, CHO₂, NH₃, and C₆H₅OH in the exhaust gasses are heated to a temperature high enough to react the impurities to form benign compounds such as CO₂, H₂O and N₂. The burner 10 is supplied with a rich fuel-air mixture so that the oxidizing gasses (typically oxygen) of the exhaust stream react with the rich fuel-air mixture in the incinerator chamber 46 to drive the reaction to completion. The treated exhaust gasses may then be vented to the atmosphere through conduit 44.

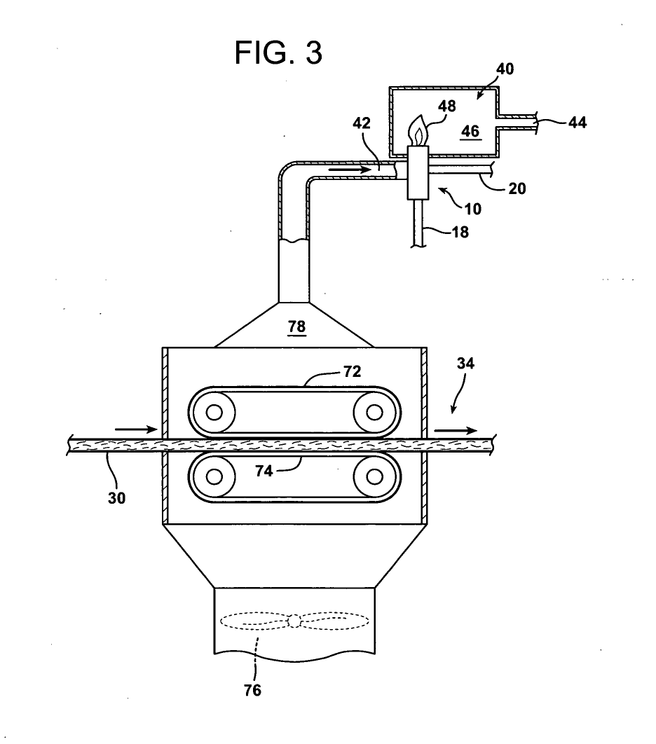

An alternate embodiment of the invention is shown in FIG. 3. FIG. 3 includes a curing oven as shown in FIG. 2. The exhaust 78 is coupled to the burner 10 of the incinerator 40 via conduit 42. The exhaust gasses enter the burner 10 where they are form a flame 48 from burner 10 and the impurities in the exhaust gasses are heated to a temperature high enough to react the impurities to form benign compounds such as CO₂, H₂O and N₂. The treated exhaust gasses may then be vented to the atmosphere through conduit 44.

### EXAMPLES

The energy and oxygen savings provided buy the present invention are set forth in Table 1. The savings in oxygen and energy were calculated based upon savings from the standard 103% of the stoichiometric amount of oxygen to drive the methane/oxygen reaction to completion. To insure that all methane is combusted in an oxygen fuel burner, the burners are typically operated at 103%. The results are shown for reactions at 100%, 80%, 70% and 60% of the stoichiometric amount required for a complete reaction. The energy savings are calculated using EQ. 1 where \dot{m} is mass of methane, cp=0.25 (the specific heat of methane (BTU/Lb./ΔT) and ΔT is the change in temperature

Energy=\dot{m}×cₚ×ΔT (EQ. 1)

As can be seen from the table, substantial oxygen and energy savings are provided by the incinerator and method of the present invention.

TABLE 1
Energy and Oxygen Savings

| | % O2 | | | | |
|---|---|---|---|---|---|
| | 103 | 100 | 80 | 70 | 60 |
| Total O2 | 2060 | 2000 | 1648 | 1442 | 1236 |
| (Ft³/HR) | | | | | |
| O₂ Saved | −60 | 0 | 400 | 600 | 800 |
| (Ft³/HR) | | | | | |
| O2 Saved | 0 | 4.986 | 38.088 | 54.648 | 71.208 |
| (Pounds/HR) | | | | | |
| Energy Saved | 0 | 0.00206 | 0.01583 | 0.02271 | 0.02959 |
| (MMBTU/HR) | | | | | |

The incinerator of the present invention may be at oxygen levels as low as 30 and 50 mole % of the stoichiometric ratio and even as low as 25 mole % of the stoichiometric ratio. At these extremely rich fuel mixtures, it is possible that undesirable CO will be generated in the incinerator.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

I claim:

1.) A process for treating an exhaust stream in an incinerator comprising the steps of:
providing at least one oxygen-fuel burner within an incinerator, the oxygen-fuel burner having a gaseous fuel conduit for providing gaseous fuel and oxygen conduit for providing oxygen;
providing an exhaust stream bearing an oxidizing gas and at least one impurity;
controlling the flow of the oxygen and gaseous fuel;
combusting the exhaust stream, gaseous fuel and oxygen within the incinerator

2.) The process for treating an exhaust stream in an incinerator, of claim 1, wherein the exhaust stream is input directly into the incinerator.

3.) The process for treating an exhaust stream in an incinerator, of claim 1, wherein the exhaust stream is input into the oxygen-fuel burner.

4.) The process for treating an exhaust stream in an incinerator, of claim 1, wherein the amounts of oxygen and gaseous fuel supplied to burner are supplied such that the fuel air mixture includes an amount of oxygen less than the stoichiometric amount of oxygen required to fully combust the fuel.

5.) The process for treating an exhaust stream in an incinerator, of claim 4, wherein the oxygen is supplied in amount less than 80 mole % of the stoichiometric ratio.

6.) The process for treating an exhaust stream in an incinerator, of claim 4, wherein the oxygen is supplied in amount between about 25 and 50 mole % of the stoichiometric ratio.

7.) The process for treating an exhaust stream in an incinerator, of claim A4, wherein the oxygen is supplied in amount between about 30 and 50 mole % of the stoichiometric ratio.

8.) An incinerator for treating an exhaust stream comprising:
a fume incinerator;
at least one oxygen-fuel burner within the incinerator, each oxygen-fuel burner having a gaseous fuel conduit for providing gaseous fuel and oxygen conduit for providing oxygen;
an exhaust stream conduit bearing an oxidizing gas and at least one impurity;
a valve for controlling the flow of the oxygen to the oxygen-fuel burner;
a valve for controlling the flow of the gaseous fuel to the oxygen-fuel burner;

9.) The incinerator for treating an exhaust stream, of claim 8, wherein the exhaust stream conduit is coupled to the incinerator.

10.) The incinerator for treating an exhaust stream, of claim 8, wherein the exhaust stream conduit is coupled to the oxygen-fuel burner.

11.) The incinerator for treating an exhaust stream, of claim 8, wherein the oxygen and gaseous fuel are supplied such that the fuel-air mixture includes an amount of oxygen less than the stoichiometric amount of oxygen required to fully combust the fuel.

12.) The incinerator for treating an exhaust stream, of claim 11, wherein the oxygen is supplied in amount less than about 80 mole % of the stoichiometric ratio.

13.) The incinerator for treating an exhaust stream, of claim 11, wherein the oxygen is supplied in amount between about 25 and about 50 mole % of the stoichiometric ratio.

14.) The incinerator for treating an exhaust stream, of claim 11, wherein the oxygen is supplied in amount between about 30 and about 50 mole % of the stoichiometric ratio.

15.) A process for treating an exhaust stream in an incinerator comprising the steps of:
providing at least one oxygen-fuel burner within an incinerator, the oxygen-fuel burner having a gaseous fuel conduit for providing gaseous fuel and oxygen conduit for providing oxygen;
providing an exhaust stream bearing an oxidizing gas and at least one impurity;
controlling the flow of the oxygen and gaseous fuel such that the fuel air mixture includes an amount of oxygen less than the stoichiometric amount of oxygen required to fully combust the fuel;
combusting the exhaust stream, gaseous fuel and oxygen within the incinerator

16.) The process for treating an exhaust stream in an incinerator, of claim 15, wherein the exhaust stream is input directly into the incinerator.

17.) The process for treating an exhaust stream in an incinerator, of claim 15, wherein the exhaust stream is input into the oxygen-fuel burner.

18.) The process for treating an exhaust stream in an incinerator, of claim 15, wherein the oxygen is supplied in amount less than about 80 mole % of the stoichiometric ratio.

19.) The process for treating an exhaust stream in an incinerator, of claim 15, wherein the oxygen is supplied in amount between about 25 and about 50 mole % of the stoichiometric ratio.

20.) The process for treating an exhaust stream in an incinerator, of claim 15, wherein the oxygen is supplied in amount between about 30 and about 50 mole % of the stoichiometric ratio.
